(19) United States
(12) Patent Application Publication
(10) Pub. No.: US 2018/0272575 A1
(43) Pub. Date: Sep. 27, 2018

(54) MOLD FOR PRODUCING A PART MADE FROM PLASTIC MATERIALS, COMPRISING AN OPTIMIZED SEALING SYSTEM

(71) Applicant: Compagnie Plastic Omnium, Lyon (FR)

(72) Inventor: Olivier TORRES, Saint-Genis-Laval (FR)

(73) Assignee: Compagnie Plastic Omnium, Lyon (FR)

(21) Appl. No.: 15/522,989

(22) PCT Filed: Oct. 26, 2015
(86) PCT No.: PCT/FR2015/052872

§ 371 Date: Apr. 28, 2017

(30) Foreign Application Priority Data
Oct. 31, 2014 (FR) 1460530

(51) Int. Cl. B29C 43/36; B29C 43/18; B29C 33/00

(52) U.S. Cl. CPC B29C 43/3607; B29C 43/18; B29C 2043/3283; B29K 2871/00; B29C 33/0038

(57) ABSTRACT

A mold used in the production of plastic materials includes a fixed element and a moving element forming a mold cavity in the closed position of the mold, at least one of the elements including at least a sealing system of the mold cavity, the sealing system being provided with at least one deformable surface made from elastic material in order to produce a sealing contact with a closure surface of the mold cavity, and the deformable surface being mounted to slide in a wall of the mold in such a way as to adjust the sealing contact.

This invention relates to the technical field of producing by moulding parts made from plastic material, especially by compression.

In particular, the invention relates to a mould adapted for producing composite parts requiring accurate alignment of the mould closing elements, such as parts comprising an insert or parts with an uneven profile on the part edge.

To produce a part made from thermoplastic or thermosetting plastic material, it is known to use a moulding method by hot compression under pressure in a closed mould, generally by displacing a moving element of the mould (moved by a press) relative to a fixed element of the mould, these elements typically being made of steel.

Generally, a loading plane consisting of sheets of plastic material, typically an SMC composite material, is placed in a compression mould. This acronym stands for “sheet moulding compound” or “sheet moulding composite”. It may be for example a sheet consisting of thermosetting resin, generally of polyester, vinylester or epoxy type, but possibly another type of thermosetting resin, which impregnates for example fibres of glass or of other reinforcement (e.g. with 20% to 30% by weight of reinforcement), often with fillers and/or a catalyst (hardener).

The press cylinder is then actuated to close the mould and transmit a moulding pressure to the plastic material.

Due to the relative displacement when hot of these various elements of the mould, it is difficult to leave a sufficiently low functional clearance between the moving element and the fixed element of the mould to ensure a seal between these two elements, due in particular to the mould assembly constraints, which involve, in the current state of the art, providing a non-zero assembly clearance at ambient temperature, which also allows the relative movement of the mould elements, without jamming. This assembly clearance remains substantially the same when the mould is heated to the moulding temperature, typically about 150° C. The larger the parts to be moulded, the greater the control required over the clearance.

This results in infiltration of resin, which has become fluid under the effect of the thermodynamic conditions in the moulding cavity, in the fixed and moving elements of the mould during moulding, which leads to the presence of burrs on the moulded parts, typically in a plane parallel to the mould closing direction, very generally vertical. These burrs, apart from the corresponding loss of material, generate high costs during the subsequent deburring operation, which requires significant time for the operator in charge of this operation.

A proposal has also already been made, in application WO2014091175, to produce compression moulds comprising moving sealing parts, or moving shims, different from the main moving element of the mould, arranged in one or more housings formed in a fixed element of the mould. These sealing parts are designed to expand and press the steel parts against each other to provide a seal. This technical option does not solve the problem satisfactorily, however, since these shims must also be assembled with an assembly and operating clearance generating burrs.

In addition, moulding of some parts leads to alignment faults of the moving and fixed elements of the mould. These alignment faults may lead to an infiltration of resin creating burrs on the moulded parts, not in a plane parallel to the mould closing direction, but in a perpendicular plane.

Such alignment faults may occur for example with parts comprising an insert or parts with an uneven profile on the part edge (non-planar, bumpy profile comprising variable shapes).

Positioning the insert in the mould, between two stacks of sheets of plastic material, increases the infiltration of resin between the fixed and moving elements of the mould and around the insert during moulding, which increases the presence of burrs on the moulded parts. Furthermore, if the insert is deformable, for example if the material composing it has little resistance to the pressure used to close the mould elements, and/or if the insert is hollow, a problem is encountered due to the pressure of the steel forming the fixed and moving elements of the mould. The pressure applied by these parts must not be too great to avoid damaging the insert.

In addition, when manufacturing an insert, there is a dimensional dispersion of the parts, in other words each insert produced on the assembly line does not have exactly the same dimensions, especially in the mould closing direction. This overall shape defect of the part, which may extend up to several millimetres from one part to another on parts of large dimensions, results in insufficiently tight alignment of the fixed and moving elements of the mould.

Such alignment faults may also occur with parts having an uneven profile on the part edge, in other words the part contour is not plane, but has shapes in relief in the mould closing direction. In this case, the two parts of the mould (fixed and moving) must fit together perfectly when closing the mould. While such a mould can be manufactured, it is however extremely difficult to guarantee that the shapes of the fixed and moving elements of the mould fit together perfectly. The precision required to adjust these elements, generally made of steel, is in fact too great with respect to that of the tool.

Thus, a part having a complicated profile profile on its edges or an insert, leads to adjustment faults creating burrs in a direction perpendicular to the mould closing direction.

These burrs are currently difficult to remove and penalise the production of this type of part (with insert and uneven profile) since they require a deburring operation after moulding.

The sealing solutions currently available do not take into account this type of burr, and in particular overmoulding of an insert in the mould, and are therefore unable to prevent burrs around an insert.

The invention aims to overcome these disadvantages and allow compression moulding in order to mould a composite part including for example an insert, without alignment fault.

The invention therefore relates to a mould for producing a part made from plastic material, comprising a fixed element and a moving element forming a mould cavity in the closed position of the mould, wherein at least one of the elements comprises at least a sealing system of the mould cavity. This sealing system is provided with at least one deformable surface made from elastic material in order to produce a sealing contact with a closure surface (surface of an insert or surface of the mould element) of the mould cavity. Furthermore, the deformable surface is mounted to slide in a wall of the mould in such a way as to adjust the sealing contact.

Thus, the deformable surface acts as a seal due, firstly to its elasticity allowing it to adapt to any shape of the closure surface, and secondly to its mobility, relative to the mould wall, allowing it to apply a pressure necessary for its elastic deformation and to reduce the gap between the deformable surface and the closure surface. This mobility of the sealing system relative to the mould wall is highly advantageous for compression moulds. For this type of mould, in fact, a seal must be provided before compressing the plastic material, since during compression, the plastic material flows and could therefore escape from the cavity.

The mould according to the invention thus improves the seal on an insert, for example, which avoids having to correct burrs after moulding.

According to the invention, the elastic material may comprise at least one polymer from the group consisting of a polyetheretherketone, known as PEEK.

Preferably, the deformable surface can move in translation parallel to a mould closing direction.

According to the invention, the sealing system may comprise means for displacing the deformable surface in the wall, adapted to press the surface against the closure surface to create a force reacting against a force exerted by the moving element during a phase of compressing the plastic material. This displacement means may be a hydraulic cylinder.

According to one embodiment, the deformable surface has a shape complementary to the surface of the closure surface in contact with said deformable surface.

According to one embodiment, the sealing system is provided with at least two deformable surfaces, one surface being mounted to slide in a wall of the fixed element and the other surface being mounted to slide in a wall of the moving element, the two surfaces cooperating to prevent the plastic material from flowing outside the mould cavity.

According to this embodiment, one of the surfaces can be mounted fixed in the wall.

The invention also relates to a method for overmoulding an insert by a plastic material by means of a mould according to the invention, wherein at least one surface of the insert is used as closure surface.

The invention will be better understood on reading the accompanying figures, which are given solely by way of example and not limiting in any way, in which:

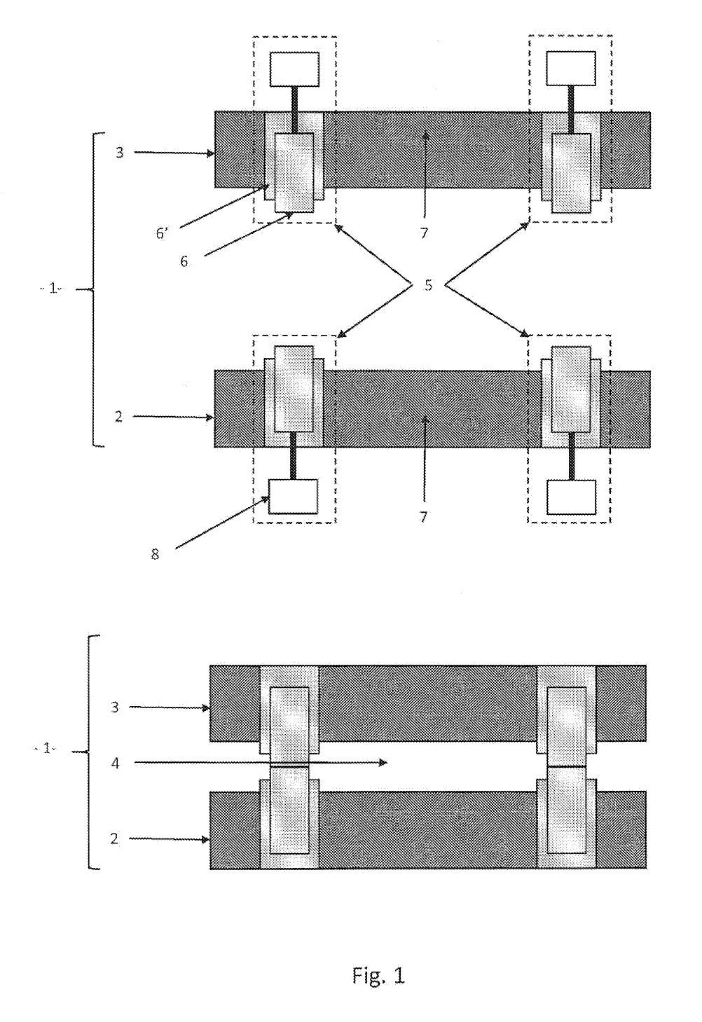

FIG. 1 is a diagrammatic representation of a mould according to a first embodiment of the invention, in open position at the top and in closed position at the bottom;

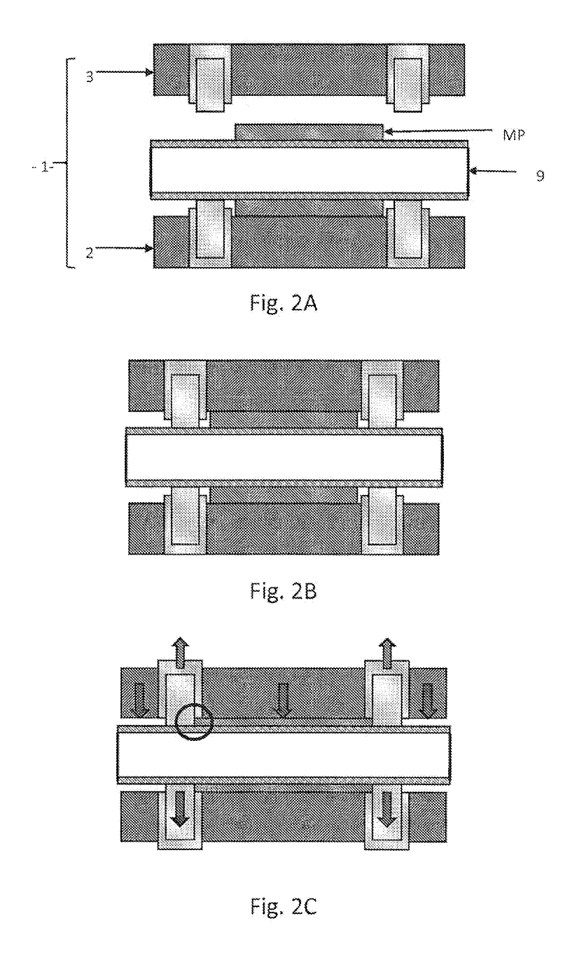

FIGS. 2A, 2B and 2C are diagrammatic representations of the mould according to the first embodiment of the invention, with positioning of the insert (FIG. 2A), closure of the mould (FIG. 2B), and in compression phase (FIG. 2C).

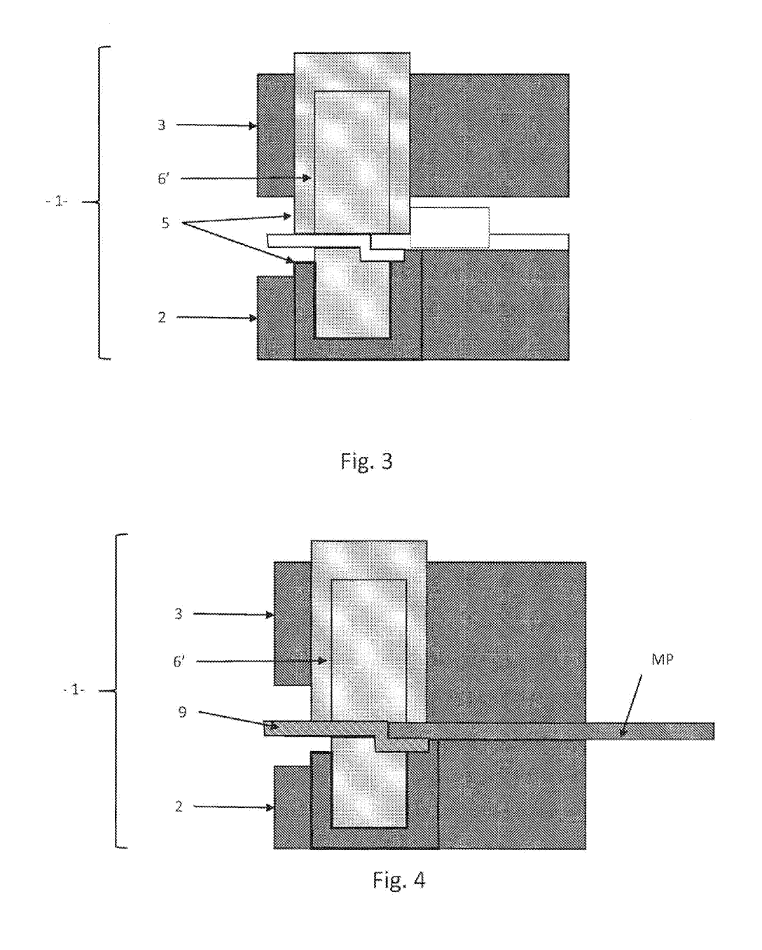

FIG. 3 is a diagrammatic representation of a mould according to a second embodiment of the invention, in open position at the top, and with positioning of the insert at the bottom.

FIG. 4 illustrates an embodiment wherein the deformable surface is pressing partially on the closure surface.

We now refer to FIG. 1, which shows an example of a mould (1) according to the invention, for producing parts made from plastic material (MP).

The mould (1) comprises a first element (2), preferably fixed, and a second element (3), preferably movable and displaceable according to a mould closing direction.

The two elements (2, 3) come into contact with each other, directly or via a member, in closed position of the mould (1), and they form the mould cavity (4). According to the examples of FIGS. 2A to 2C, the two elements (2, 3) come into contact with an insert (9), defining the overmoulding cavity of the insert (9). FIG. 2A illustrates the mould (1) during the step of positioning a metal or composite insert (9), and sheets of plastic material (MP) of type SMC in the mould (1).

One of the elements (2, 3) of the mould (1) comprises at least a sealing system (5) of the mould cavity (4) so as to prevent any plastic material (MP) from flowing outside the cavity (4), between the first element (2) and the second element (3) (in the case of FIG. 1). This sealing system (5) comprises at least one block of plastic material provided with a deformable surface (6) to form a sealing contact with a closure surface of the mould cavity (4). An elastic material means a material capable of accepting a residual reversible deformation of 0.1 mm, at least at the usual moulding pressures and temperatures (pressure of approximately 100 bars and temperature of approximately 150° C.). This deformable surface (6) made from elastic material is mounted to slide in a wall (7) of the mould (1). Preferably, the deformable surface (6) can move in translation parallel to the closing direction of the mould (1).

Thus, the deformable surface (6) acts as a seal due, firstly to its elasticity allowing it to adapt to any shape of the closure surface, and secondly to its mobility, allowing it to apply a pressure necessary for its elastic deformation and to reduce the gap between the deformable surface (6) and the closure surface.

The closure surface can be the surface of one of the elements (2,3) of the mould or the surface of an insert (9) as illustrated on FIGS. 2A to 2C and 4. The deformable surface (6) may press partially on the closure surface as illustrated on FIG. 4, in other words only part of the deformable surface (6) is in contact with the closure surface. The other part may be in direct contact with the plastic material (MP).

According to one embodiment, the elastic material of the deformable surface (6) comprises at least one or more polymers from the group consisting of a polyetheretherketone, known as PEEK.

There are several grades of this PEEK material. To prevent burrs in a direction perpendicular to the mould closing direction, and in particular between the surface (6) and the closure surface, those skilled in the art will choose, depending on the materials implemented, the pressures and temperatures implemented, the PEEK grade allowing deformations of the thickness of the surface (6), in the mould closing direction, of about 0.1 mm, to allow an adjustment creating a seal between the elements closing the mould cavity (4).

The elastic material may also comprise, alone or in combination, Teflon® PFA (PTFE), VITON® (synthetic rubber from the family of fluorinated elastomers).

The elastic material may also comprise other components. For example, the elastic material may comprise at least 65% by weight, and preferably at least 90% by weight of one or more polymers from the group consisting of polyetheretherketone, known as PEEK, polyimide, known as PI, polyamide-imide, known as PAI, polyphenylene sulphide, known as PPS, and VITON®.

According to the invention, the deformable surface (6) may be in direct contact with the plastic material (MP).

The deformable surface (6) preferably has a shape complementary to the closure surface, such as the insert (9), in contact with the deformable surface (6). As illustrated on FIGS. 3 and 4, irrespective of the shape of the insert (9), the surface (6) produces optimum sealing.

According to the embodiment of FIGS. 1 and 2A to 2C, the sealing system (5) comprises blocks of elastic material provided with a deformable surface (6), each block being housed by insertion in a support (6′). This support (6′), which therefore carries the deformable surface (6), provides a clean contact with the closure surface, such as the outer surface of the insert (9).

One or more blocks of elastic material can be inserted in the mould (1). They are preferably placed in the upper and lower parts of the mould, in other words on the fixed element (2) and on the moving element (3).

According to the examples of FIGS. 1 and 2A to 2C, the sealing system (5) is provided with at least two deformable surfaces (6). One deformable surface is mounted to slide in the wall (7) of the fixed element (2) and the other deformable surface is mounted to slide in a wall (7) of the moving element (3). The two deformable surfaces (6) in contact with the insert (9) cooperate so as to prevent the plastic material (MP) from flowing outside the mould cavity (4). They are therefore opposite each other, as illustrated on FIGS. 1 and 2A to 2C, so as to create an optimum seal before starting compression.

Advantageously, the sealing system (5) comprising a means (8) for displacing the deformable surface (6) in the wall (7). This system presses the deformable surface (6) against the closure surface, such as the insert (9), to create a force reacting against a force exerted by the moving element (3) during the phase of compressing the plastic material (MP). FIG. 2C illustrates the forces involved during the compression phase.

On the example of FIGS. 1 and 2A to 2C, the deformable surfaces (6), via the supports (6′), are controlled by hydraulic cylinders (8) so as to create an optimum seal before starting compression.

According to another embodiment, illustrated on FIGS. 3 and 4, the sealing system (5) is provided with at least two deformable surfaces (6), one deformable surface being mounted to slide in a wall (7) of one element (2, 3) and the other deformable surface being mounted fixed to slide in the wall (7) of the other element (3, 2). The two deformable surfaces in contact with the closure surface, such as the insert (9), cooperate so as to prevent the plastic material (MP) from flowing outside the mould cavity (4). They are therefore opposite each other, as illustrated on FIGS. 3 and 4, so as to create an optimum seal before starting compression.

The invention also relates to a method for overmoulding an insert by a plastic material by means of a mould (1) according to the invention.

The method comprises at least the following steps according to the example of FIGS. 1 and 2A to 2C:
the insert (9) to be moulded is positioned with the plastic material (MP) on blocks of elastic material, provided with a deformable surface (6), the punch (2) in high position (when overmoulding on both sides).
the press (3) is closed until the deformable surfaces (6) of the upper part are in contact with the insert (9). The plastic material (MP) is not yet compressed, but the part end zone is sealed.
the press (3) continues to move down to the nominal size of the part to be moulded, and a pressure is applied to make the plastic material (MP) flow and polymerise. The deformable surfaces (6) are still pressing on the insert (9) to provide a seal: a counter-pressure is applied on the sealing system (5) by means of the hydraulic cylinders. The deformable surfaces (6) will move back (inside the wall of the mould in which they are positioned) as the press (3) moves down under pressure.
once the transformation process is completed (flowing, curing), the press (3) opens and the transformed part is ejected.

In the case of deformable surfaces (6) in the upper and lower parts, they can help to eject the part on its periphery.

1. A mold for a production of a part including plastic material (MP), the mold comprising:
a fixed element and a moving element forming a mold cavity in a closed position of the mold, wherein:
at least one of the fixed element and the moving element includes at least a sealing system of the cavity, said sealing system including at least one deformable surface including elastic material and forming a sealing contact with a closure surface of the mold cavity, and
said at least one deformable surface being configured to slide in a wall of the mold to adjust the sealing contact.

2. The mold according to claim 1, wherein said elastic material comprises at least one polymer including polyetheretherketone.

3. The mold according to claim 1, wherein the at least one deformable surface is configured to move in translation parallel to a mold closing direction.

4. The mold according to claim 1, wherein the sealing system comprises a means for displacing said at least one deformable surface in said wall and configured to press said surface against the closure surface to create a force reacting against a force exerted by the moving element during a phase of compressing the plastic material (MP).

5. The mold according to claim 4, wherein the displacement means comprises a hydraulic cylinder.

6. The mold according to claim 1, wherein the at least one deformable surface has a shape that is complementary to the surface of the closure surface that is in contact with said at least one deformable surface.

7. The mold according to claim 1, wherein said sealing system comprises at least two deformable surfaces including one surface configured to slide in a wall of the fixed element and an other surface configured to slide in a wall of the moving element, the at least two deformable surfaces together being configured to prevent the plastic material (MP) from flowing outside the overmoulding cavity (4).

8. The mold according to claim 7, wherein one of the surfaces is fixed in the wall.

9. A method for overmoulding an insert by a plastic material by means of the mold according to claim 1, wherein at least one surface of the insert is as closure surface.
